(19) United States
(12) Patent Application Publication
(10) Pub. No.: US 2017/0034283 A1
(43) Pub. Date: Feb. 2, 2017

(54) MANAGEMENT OF MULTIPATH COMMUNICATION SESSIONS

(71) Applicant: Samsung Electronics Co., Ltd., Suwon-si (KR)

(72) Inventor: Sukumar MOHARANA, Bangalore (IN)

(21) Appl. No.: 15/213,771

(22) Filed: Jul. 19, 2016

(30) Foreign Application Priority Data
Jul. 27, 2015 (IN) 3842/CHE/2015

(51) Int. Cl. H04L 29/08; H04L 29/06

(52) U.S. Cl. CPC H04L 67/14; H04L 65/80; H04L 67/02; H04L 65/608

(57) ABSTRACT

The present invention relates to the field of multipath communications and more particularly to management of ongoing multipath communication sessions. Embodiments herein disclose management of an ongoing multipath session, wherein a server, which is a part of the ongoing multipath session, informing devices connected to the server for the multipath session about additional sub-flows, on additional sub-flows being available for the devices. Embodiments herein disclose management of an ongoing multipath session, wherein a device can swap an ongoing sub-flow of the multipath session with another sub-flow, in an automated manner. Embodiments herein disclose management of ongoing multipath session, wherein a device can swap an ongoing sub-flow of the multipath session with another sub-flow, in a manual manner.

### CROSS-REFERENCE TO RELATED APPLICATION(S)

This application claims priority under 35 U.S.C. §119(a) to an Indian Patent Application filed in the Indian Intellectual Property Office on Jul. 27, 2015 and assigned Serial No. 3842/CHE/2015, the entire disclosure of which is incorporated herein by reference.

### TECHNICAL FIELD

The present invention relates to the field of multipath communications and more particularly to management of ongoing multipath communication sessions.

### BACKGROUND

Currently, there are multiple communication interfaces available such as Wi-Fi, cellular data interfaces, LAN (Local Area Network) interfaces, Bluetooth, NFC (Near Field Communication) and so on. Also, communication devices are configured with multiple communication interfaces, wherein the devices can use one or more of the communication interfaces in parallel or one at a time, depending on the configuration. These devices can be configured for using one or more of the communication interfaces for a single flow to a server, wherein flow refers to an activity being performed by the device such as downloading data, uploading data, streaming audio and/or video sessions and so on. This is referred to herein as multipath communication. The server can enable the device to perform the flow. For example, if the device is downloading data, the server can be a data server, a web server, or any other type of server, which comprises data. In another example, if the device is streaming video, the server can be a video server, a server belonging to a video provider (such as Netflix, YouTube and so on).

However, in multipath communications, the load on the server can be high. This is because the server has to serve one device, using more than one sub-flow, resulting in the server have to perform co-ordination between the sub-flows to manage the flow. Sub-flow herein refers to each connection made by the device to the server as a part of the flow.

Further, the server will have to deal with multiple probing requests across multiple interfaces from devices for access to the server (either for ongoing multipath sessions or new multipath sessions). This can significantly increase the burden on the server, as the server can only have a limited number of communication interfaces available at a time. The limited number of communication interfaces can be due to a plurality of reasons such as due to the load currently on the server, a pre-configured limit of number of connections on each communication interface and so on.

### SUMMARY

The principal object of the embodiments herein is to manage an ongoing multipath session, wherein a server informs communication devices connected to the server for the multipath session regarding availability of additional sub-flows, upon determining additional sub-flows being available for the devices.

Another object of the invention is to manage an ongoing multipath session, wherein a communication device can swap an ongoing sub-flow of the multipath session with another sub-flow, in an automated manner.

Another object of the invention is to manage an ongoing multipath session, wherein a communication device can swap an ongoing sub-flow of the multipath session with another sub-flow, in a manual manner.

Accordingly the invention provides a method for managing a multipath communication session between a server and a communication device, the method comprising dynamically determining by the server, available sub-flows for the multipath communication session; assigning at least one available sub-flow to the communication device by the server upon determining at least one sub-flow to be available, wherein the communication device is already in communication with the server using the multipath communication session; and allowing the communication device to use the assigned sub-flow for communication with the server.

Accordingly the invention provides a system for managing a multipath communication session between a server and at least one communication device, the system further configured for dynamically determining by the server, available sub-flows for the multipath communication session; assigning at least one available sub-flow to the communication device by the server upon determining at least one sub-flow to be available, wherein the communication device is already in communication with the server using the multipath communication session; and allowing the communication device to use the assigned sub-flow for communication with the server.

Accordingly the invention provides a server in communication with at least one communication device using a multipath communication session, the server further configured for dynamically determining available sub-flows for the multipath communication session; and assigning at least one available sub-flow to the communication device upon determining at least one sub-flow to be available, wherein the communication device is already in communication with the server using the multipath communication session.

Accordingly the invention provides a communication device in communication with at least one server using a multipath communication session, the device further configured for receiving a notification regarding at least one available sub-flow from the server, upon the server determining at least one sub-flow to be available; and allowing the assigned sub-flow to be used for communication with the server.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

This invention is illustrated in the accompanying drawings, throughout which like reference letters indicate corresponding parts in the various figures. The embodiments herein will be better understood from the following description with reference to the drawings, in which:

FIG. 1 illustrates a plurality of communication devices configured for multipath communication, communicating with a server using at least one communication interface, according to embodiments as disclosed herein;

FIG. 2 depicts a communication device comprising of a plurality of communication interfaces, according to embodiments as disclosed herein;

FIG. 3 depicts an example of a communication device comprising of a plurality of communication interfaces, according to embodiments as disclosed herein;

FIG. 4 depicts a server, according to embodiments as disclosed herein;

FIG. 5 depicts a communication device capable of communicating using multipath communication sessions, according to embodiments as disclosed herein;

FIGS. 6A, 6B, 6C and 6D depict example screenshots of the interface of the communication device when sub-flows are added, according to embodiments as disclosed herein;

FIGS. 7A, 7B, 7C and 7D depict example screenshots of the interface of the communication device when sub-flows are swapped, according to embodiments as disclosed herein;

FIG. 7E depicts example screenshots of the interface which enables a user of the communication device to control the interfaces, according to embodiments as disclosed herein;

FIG. 8 is a flowchart depicting the process of initiating a multipath session with a device, according to embodiments as disclosed herein;

FIG. 9 depicts a process of a communication device, communicating with a server using a multipath session, being assigned additional sub-flows in response to a request from the device, according to embodiments as disclosed herein;

FIG. 10 depicts a process of a communication device, communicating with a server using a multipath session, being assigned additional sub-flows automatically, according to embodiments as disclosed herein;

FIG. 11 is a flow chart depicting the process of the server managing the process of swapping sub-flows, according to embodiments as disclosed herein;

FIG. 12 is a flowchart depicting the process of the communication device swapping sub-flows, according to embodiments as disclosed herein;

FIG. 13 is a sequence diagram depicting the flow of messages between the communication device and the server, on the communication device being assigned new sub-flows, according to embodiments as disclosed herein; and

FIG. 14 is a sequence diagram depicting the flow of messages between the communication device and the server on the swapping sub-flows, according to embodiments as disclosed herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein can be practiced and to further enable those of skill in the art to practice the embodiments herein. Accordingly, the examples should not be construed as limiting the scope of the embodiments herein.

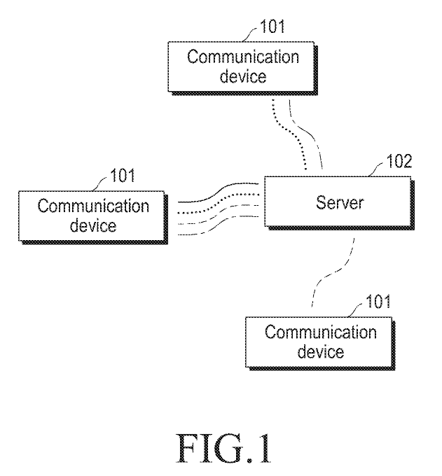

The embodiments herein achieve a method and system for managing an ongoing multipath session by adding one or more sub-flows from an ongoing multipath session and/or switching one or more sub-flows in an ongoing multipath session. Referring now to the drawings, and more particularly to FIGS. 1 through 14, where similar reference characters denote corresponding features consistently throughout the figures, there are shown preferred embodiments.

Multipath communication can refer to a communication device performing communication over a plurality of communication interfaces for a single flow, in parallel, so as to enable the communication device to complete the flow. The flow can refer to an activity being performed by the communication device such as downloading data, uploading data, streaming audio and/or video sessions and so on. Each flow can comprise of a plurality of sub-flows, wherein each sub-flow corresponds to each communication interface being used for the flow.

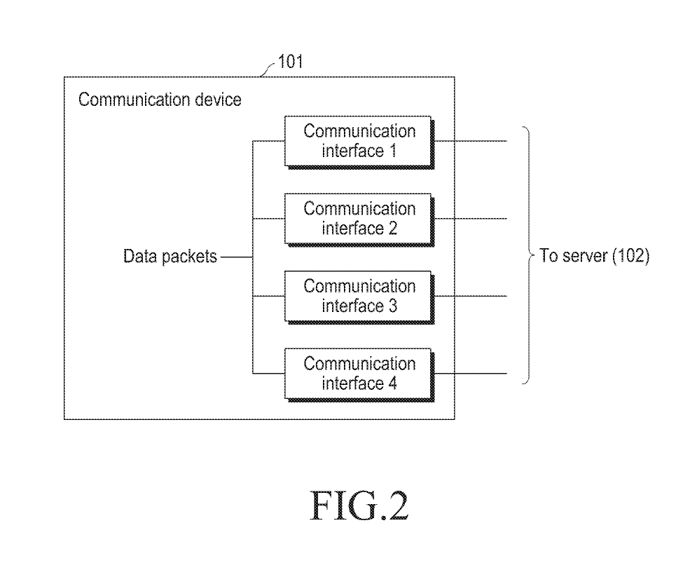

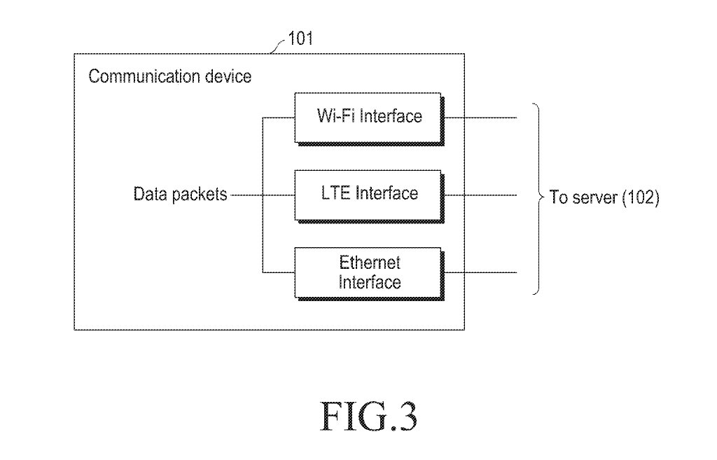

The term ‘communication device’ can comprise any device, which can perform multipath communication using a plurality of communication interfaces present on the communication device (as depicted in FIG. 2). Examples of the communication device can be a mobile phone, a smart phone, a tablet, a computer, a laptop, a communication dongle, a wearable computing device, an embedded device and so on. Examples of the communication interface can be a Wi-Fi communication interface, a cellular communication interface (such as LTE (Long Term Evolution), 3GPP (3^{rd} Generation Partnership Project) and so on), a PPP (Point-to-Point) protocol based communication interface, an Ethernet based communication interface, a RmNET based communication interface and so on. FIG. 3 depicts an example of a communication device 101 comprising of three communication interfaces.

The term ‘server’ can be a server configured to enable communication devices to connect to the server using multipath sessions. The server can also enable communication devices to connect to the server using non-multipath sessions. Examples of the type of server comprise of application server, database servers, media servers, web servers, enterprise servers, gaming servers and so on.

Embodiments herein enable managing of an ongoing multipath session, wherein the server informs communication devices connected to the server for the multipath session about additional sub-flows, on additional sub-flows being available for the communication devices.

Embodiments herein enable the communication device to swap an ongoing sub-flow of the multipath session with another sub-flow, in an automated and/or manual manner.

FIG. 1 illustrates a plurality of communication devices configured for multipath communication, communicating with a server using at least one communication interface, according to embodiments as disclosed herein. The figure depicts a plurality of communication devices 101 communicating with a server 102. The communication device 101 can be enabled to perform communication using MPTCP (Multipath Transfer Control Protocol (TCP)) protocol for communication using a plurality of communication interfaces (as depicted in FIG. 2). The communication device 101 can use one or more sub-flows to communicate with the server 102. The communication device 101 can send a request to the server 102, on the communication device 101 detecting that further sub-flows are required. The request can be inserted in a SYNC message sent from the communication device 101 to the server 102.

The server 102 can monitor the sub-flows assigned to each communication device 101, which are currently communicating with the server 102 using multipath sessions. The server 102 can check for any available sub-flows for each of the communication devices 101. On detecting an available sub-flow, the server 102 can check if the communication device 101 can use the sub-flow. The server 102 can also assign sub-flows to a communication device 101 based on a request for a sub-flow received from the communication device 101. The server 102 can further check for other factors such as QoS (Quality of Service) for each of the communication device 101 and so on. If a sub-flow can be assigned to more than one communication device 101, the server 102 can decide on one or more communication devices to whom the sub-flows have to be assigned based on factors such as the QoS for each communication device 101, the number of current sub-flows assigned to each communication device 101, the time that the request for the sub-flow was received from the communication device 101, and so on. The server 102 can communicate the availability of the sub-flow to the communication device 101 using a suitable means.

The communication device 101, on receiving the communication from the server 102, that the communication device 101 can join a sub-flow, joins the sub-flow. The communication device 101 can then exchange data with the server 102 using the new sub-flow.

The communication device 101 can switch from an ongoing sub-flow to another sub-flow, on receiving an indication from the server 102 that another sub-flow is available. The communication device 101 can switch on receiving an indication from a user of the communication device 101, that the sub-flow needs to be switched. The user can decide to switch the sub-flows based on criteria such as speed of the sub-flow that became available (as compared to the sub-flow being used currently by the communication device 101), costs associated with the sub-flow and so on. The communication device 101 can also switch automatically, based on criteria such as speed of the sub-flow that became available (as compared to the sub-flow being used currently by the communication device 101), costs associated with the sub-flow and so on. The user of the communication device 101 can configure the criteria.

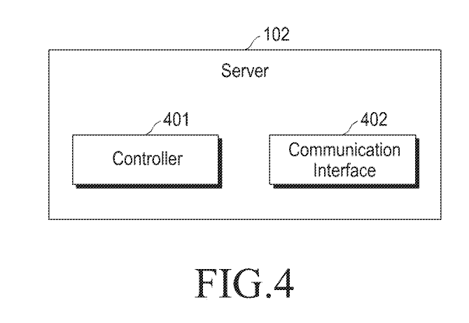

FIG. 4 depicts a server, according to embodiments as disclosed herein. The server 102, as depicted, comprises of a controller 401 and a communication interface 402. The server 203 can use the communication interface 402 to communicate with a plurality of communication devices 101.

The controller 401 can monitor the sub-flows assigned to each communication device 101, which are currently communicating with the server 102 using multipath sessions. The controller 401 can check for any available sub-flows for each of the communication devices 101. On detecting an available sub-flow, the controller 401 can check if the communication device 101 can use the sub-flow. The controller 401 can check if the communication device 101 is configured with the communication interface required to use the sub-flow. The controller 401 can also assign sub-flows to a communication device 101 based on a request for a sub-flow received from the communication device 101. The controller 401 can further check for other factors such as QoS (Quality of Service) for each of the communication device 101, the current number of sub-flows assigned to the communication device 101 and so on. If a sub-flow can be assigned to more than one communication device 101, the controller 401 can decide on one or more communication devices to whom the sub-flows have to be assigned based on factors such as the QoS for each communication device 101, the number of current sub-flows assigned to each communication device 101, the time that the request for the sub-flow was received from the communication device 101, and so on. In an embodiment herein, if a communication device 101 is using only a single sub-flow and one sub-flow becomes available, the controller 401 can inform the communication device 101 and the controller 401 can enable the communication device 101 to add the sub-flow to the existing sub-flow or the controller 401 can enable the communication device 101 to swap the existing sub-flow for the new sub-flow.

The controller 401 can communicate the availability of the sub-flow to the communication device 101 using a suitable means such as a SYNC_ACK message, application specific packets (wherein the application specific packets can be defined and exchanged between the server 102 and the communication device 101 to determine allowed number of sub-flows, requesting for sub-flows and so on), a new stream (for example, in case of HTTP 2.0 (HyperText Transfer Protocol 2.0) using MPTCP, the new stream can be used to push the messages containing allowed number of sub flows on an existing TCP sub-flow), RTCP (RTP (Real-Time Transport Protocol) Control Protocol) messages (for example, in case of Multipath RTP) and so on.

The controller 401 can include a timeout period, when sending the communication to the communication device 101. The communication device 101 has to respond to the server 102 within the timeout period. The response can comprise of the communication device 101 joining the sub-flow, refusing to join the sub-flow and so on. If the controller 401 does not receive any response from the communication device 101 within the timeout period or the communication device 101 indicates that the communication device 101 is not joining the sub-flow, the controller 401 can make the sub-flow available to other communication devices.

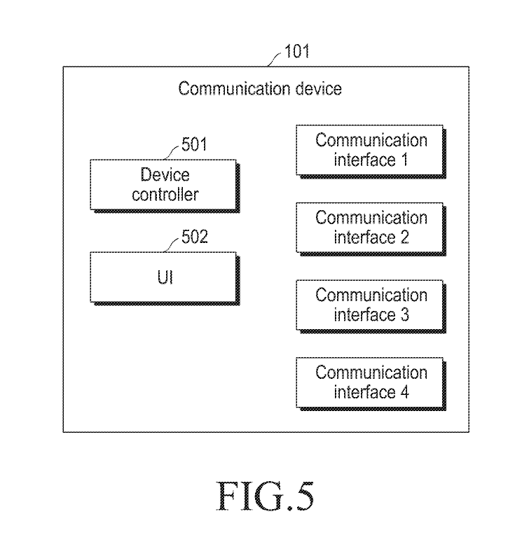

FIG. 5 depicts a communication device capable of communicating using multipath communication sessions, according to embodiments as disclosed herein. The communication device 101, as depicted, comprises of a device controller 501, a UI (User Interface) 502, and a plurality of communication interfaces. The device controller 501 can use the plurality of communication interfaces to communicate with a plurality of servers 102, wherein the communication device 101 can use more than one communication interface to communicate with the servers 102. The UI 502 can enable a user of the communication device 101 to interact with the communication device 101. The UI 502 can comprise of a display screen, a touchscreen, a physical keyboard, a virtual keyboard, at least one physical button/switch, at least one virtual button/switch, or any other equivalent means which will enable at least one user to interact with the communication device 101.

The device controller 501 can send a request to the server 102, on the communication device 101 detecting that further sub-flows are required. The device controller 501 can send the request to the server 102, using at least one of the communication interfaces. The request can comprise of information such as the current number of sub-flows being used by the communication device 101, the possible additional number and types of sub-flows that can be used by the communication device 101, the QoS levels assigned to the communication device 101 and so on. The request can be inserted in a SYNC message by the device controller 501, wherein the SYNC message can be send from the communication device 101 to the server 102.

The device controller 501, on receiving the communication from the server 102, that the communication device 101 can join a sub-flow, joins the sub-flow. The communication device 101 can then exchange data with the server 102 using the new sub-flow.

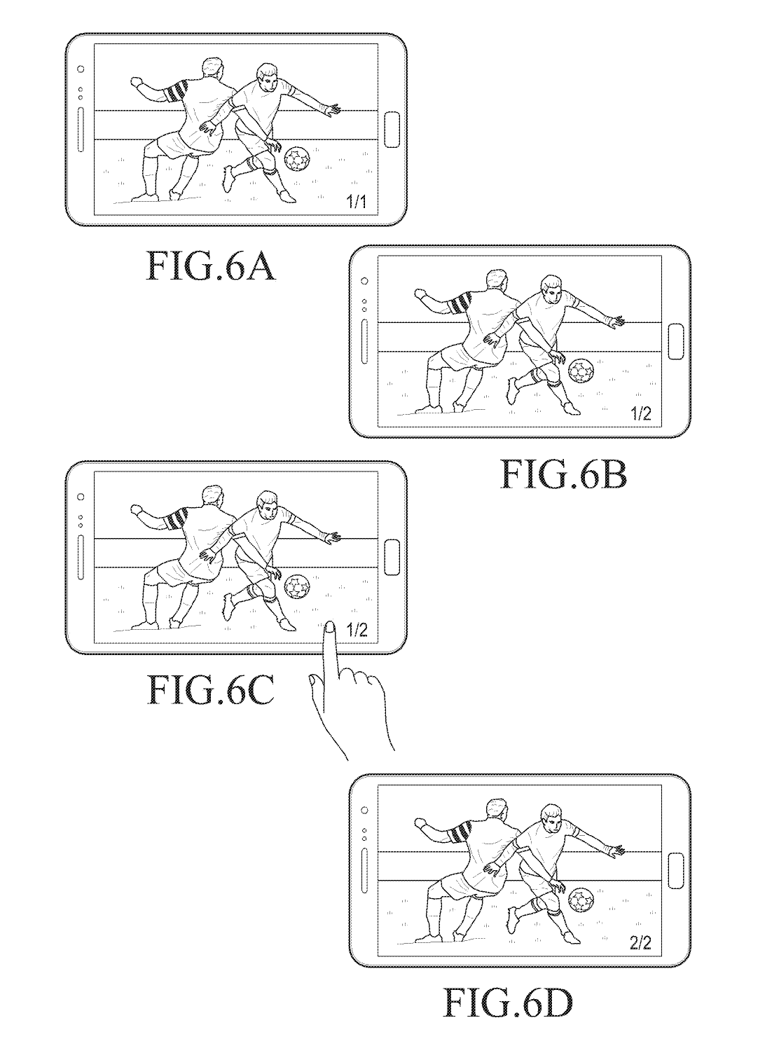

In an example herein, consider that the user is watching a video on the UI 502 (as depicted in FIG. 6A). Consider that the number of sub-flows being used currently and the number of total sub-flows available for use by the communication device 101 are denoted to the user. The number of sub-flows being used currently and the number of total sub-flows available for use by the communication device 101 can be overlaid on the UI 502 in a permanent manner (which can be opaque, so as not to interfere with the viewing experience of the user). The number of sub-flows being used currently and the number of total sub-flows available for use by the communication device 101 can be hidden from the user and can be made visible to the user, on the user making a pre-defined action such as a swiping gesture, a pinching gesture and so on. In the example considered herein, the number of sub-flows being used currently and the number of total sub-flows available for use by the communication device 101 are displayed to the user in the bottom right of the screen in the format “the number of sub-flows being used currently/the number of total sub-flows available for use by the communication device 101” (as depicted in FIG. 6A).

On a new sub-flow becoming available and the server 102 sending the indication to the communication device 101 that the sub-flow is available, the device controller 501 updates the interface indicating to the user that an additional sub-flow is available (as depicted in FIG. 6B). The user can add the additional sub-flow using a suitable gesture such as a swiping gesture, a pinching gesture, a clicking gesture, a clicking action, and so on (as depicted in FIG. 6C). In an embodiment herein, the sub-flow can be added automatically, based on pre-configured options (either by the user, the device manufacturer, a network operator through which the communication device connects and so on). On the sub-flow being added, the device controller 501 updates the UI 502 (as depicted in FIG. 6D).

On receiving an indication from the server 102 that another sub-flow is available, the device controller 501 can provide an indication to the user that another sub-flow is available using the UI 502. The user can provide an input indicating that the user wants to swap the sub-flow that is currently being used to the new sub-flow. The device controller 501 can also automatically swap the sub-flow, based on pre-configured options such as the connection interface used by the new sub-flow, the speed of the sub-flow that became available (as compared to the sub-flow being used currently by the communication device 101), costs associated with the sub-flow and so on. On swapping the sub-flow, the communication device controller 501 can provide an indication to the user that the sub-flow has been swapped, using the UI 502.

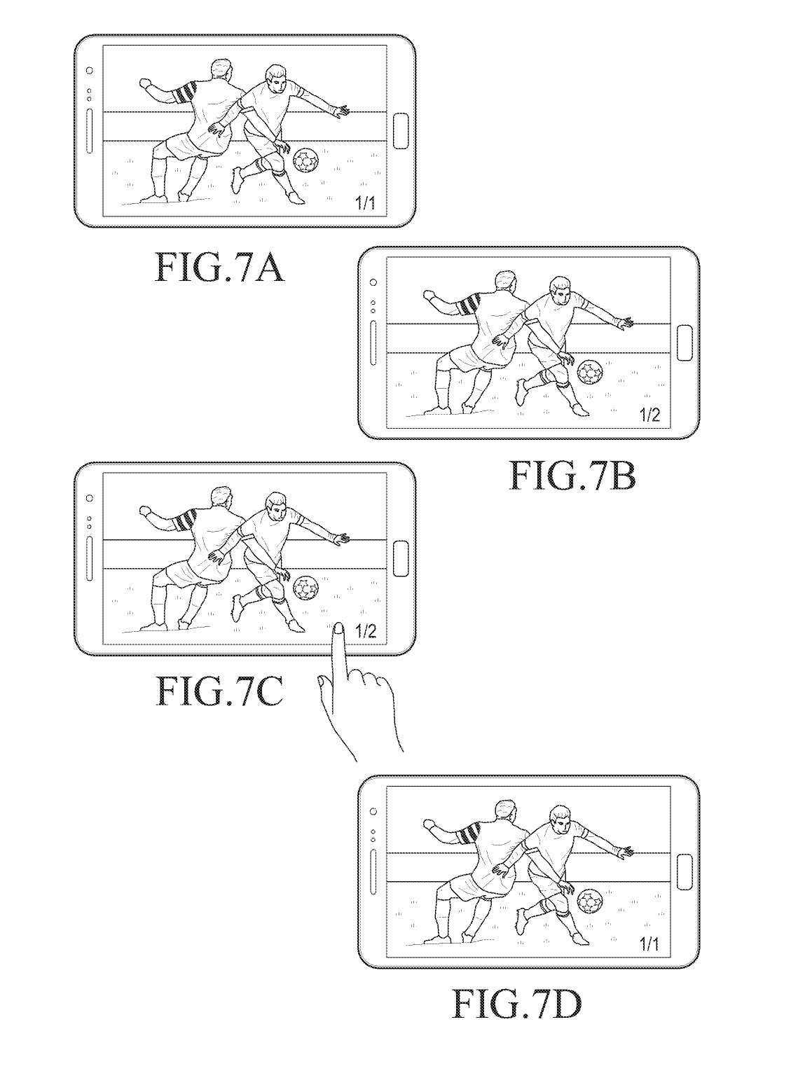

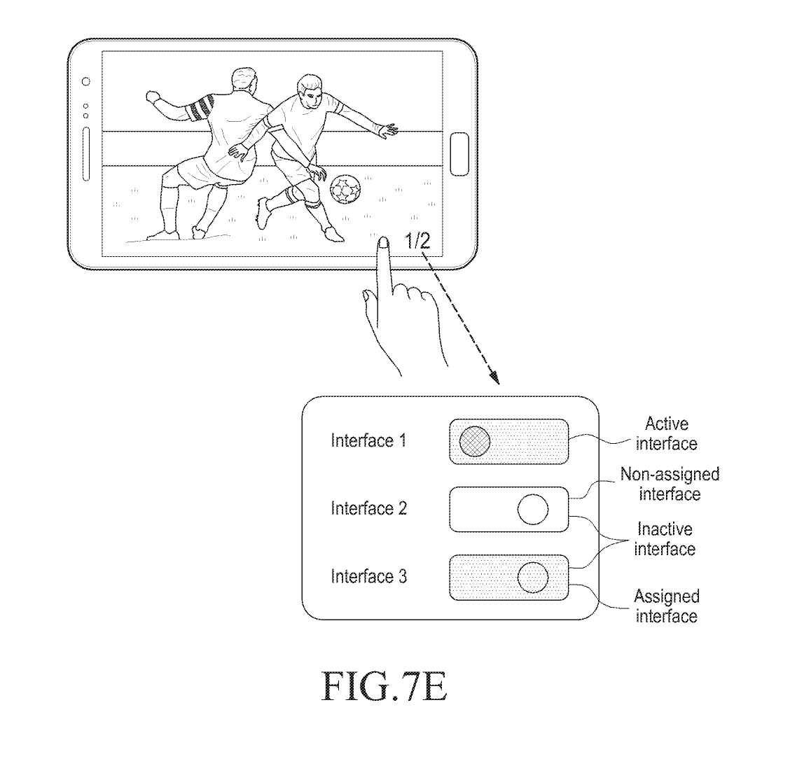

In an example herein, consider that the user is watching a video on the UI 502 (as depicted in FIG. 7A). Consider that the number of sub-flows being used currently and the number of total sub-flows available for use by the communication device are denoted to the user. The number of sub-flows being used currently and the number of total sub-flows available for use by the communication device can be overlaid on the UI 502 in a permanent manner (which can be opaque, so as not to interfere with the viewing experience of the user). The number of sub-flows being used currently and the number of total sub-flows available for use by the communication device can be hidden from the user and can be made visible to the user, on the user making a pre-defined action such as a swiping gesture, a pinching gesture and so on. In the example considered herein, the number of sub-flows being used currently and the number of total sub-flows available for use by the communication device are displayed to the user in the bottom right of the screen in the format “the number of sub-flows being used currently/the number of total sub-flows available for use by the communication device” (as depicted in FIG. 7A).

On a new sub-flow becoming available and the server 102 sending the indication to the communication device 101 that the sub-flow is available, the device controller 501 updates the interface indicating to the user that an additional sub-flow is available (as depicted in FIG. 7B) for swapping. The user can swap the sub-flow using a suitable gesture such as a swiping gesture, a pinching gesture, a clicking gesture, a clicking action, and so on (as depicted in FIG. 7C). In an embodiment herein, the sub-flow can be swapped automatically, based on pre-configured options (either by the user, the device manufacturer, a network operator through which the communication device 101 connects and so on). On the sub-flow being swapped, the device controller 501 updates the UI 502 (as depicted in FIG. 7D).

FIG. 7E depicts an example of the user viewing the statuses of the interfaces. The user can view the statuses using a pre-defined action such as a long press gesture, a swiping gesture, a pinching gesture, a short press gesture, a pressing action on a physical interface such as a button and so on. The UI 502 can enable the user to view the statuses in the form of a pop-up, widget and so on. The UI 502 can enable the user to control the ON/OFF status of the interfaces, swap interfaces and so on, using a suitable means such as a toggle switch, a drop down menu, and so on. The assigned sub-flows can be made visible to the user, enabling the user to add or swap interfaces, which have been assigned to the communication device 101.

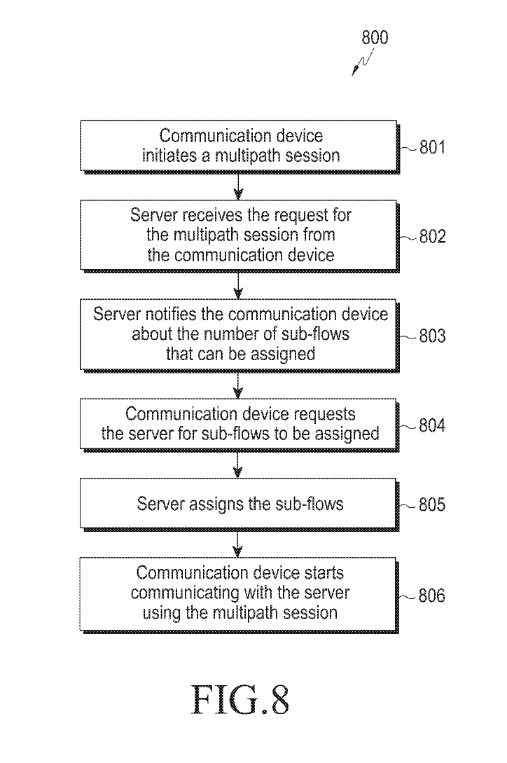

FIG. 8 is a flowchart depicting the process of initiating a multipath session with a communication device, according to embodiments as disclosed herein. The communication device 101 initiates (801) a multipath session with the server 102. The communication device 101 can use any active and available communication interface present on the communication device 101 to create the multipath session. The server 102 receives (802) the request for the multipath session from the communication device 101. Based on the sub-flows that are available (based on the number of communication devices currently communicating with the server, the available bandwidth on each of the communication interfaces and so on) (hereinafter referred to as ‘n’), the server 102 notifies (803) the communication device 101 about the possible number of sub-flows that can be assigned to the communication device 101. The server 102 can notify the communication device 101 that no sub-flows are currently available and to attempt to request for a new multipath session after a pre-defined or random time interval. On receiving the notification from the server 102 about the possible number of sub-flows, the communication device 101 requests (804) for sub-flows to be assigned to the communication device 101, wherein the number of sub-flows requested to be assigned to the communication device 101 is less than or equal to the number of possible sub-flows as per the notification from the server 102 (n). On receiving the request from the communication device 101 with the number of sub-flows, the server 102 assigns (805) the sub-flows to the communication device 101 and the communication device 101 starts (806) communicating with the server 102 using the multipath session. The various actions in method 800 may be performed in the order presented, in a different order or simultaneously. Further, in some embodiments, some actions listed in FIG. 8 may be omitted.

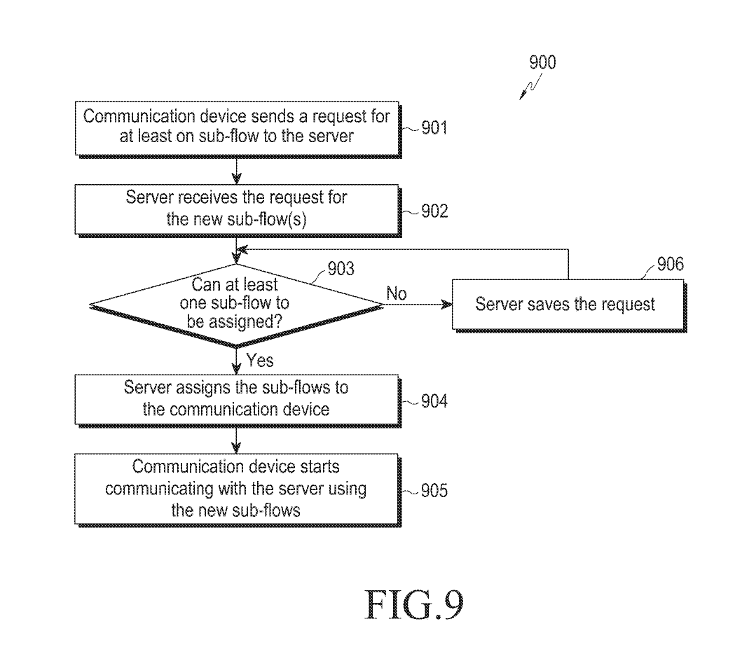

FIG. 9 depicts a process of a communication device, communicating with a server using a multipath session, being assigned additional sub-flows in response to a request from the communication device, according to embodiments as disclosed herein. Consider that the communication device 101 is in a multipath session with the server 102. The communication device 101 sends (901) a request for at least one sub-flow to the server 102. The communication device 101 can use any active and available communication interface present on the communication device 101 for the new sub-flow(s). The server 102 receives (902) the request for the new sub-flow(s) from the communication device 101. Based on the sub-flows that are available (based on the number of communication devices currently communicating with the server, the available bandwidth on each of the communication interfaces and so on) (hereinafter referred to as ‘n’), the server 102 checks (903) if it is possible for at least one sub-flow to be assigned to the communication device 101. If it is possible for at least one sub-flow to be assigned to the communication device 101 (wherein the number of sub-flows assigned to the communication device 101 can be less than or equal to the number of sub-flows requested by the communication device 101), the server 102 assigns (904) the sub-flows to the communication device 101 and the communication device 101 starts (905) communicating with the server 102 using the new sub-flows. If at least one sub-flow is not available to be assigned to the communication device 101, the server 101 saves (906) the request for the communication device 101 and keeps checking for at least one sub-flow to be available, wherein the sub-flow can be assigned to the communication device 101. The various actions in method 900 may be performed in the order presented, in a different order or simultaneously. Further, in some embodiments, some actions listed in FIG. 9 may be omitted.

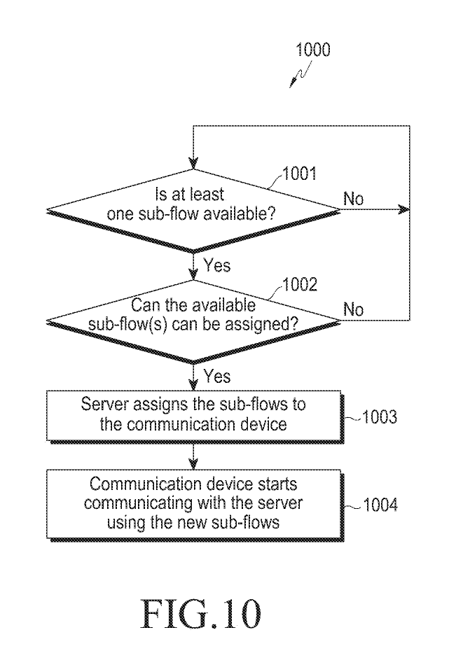

FIG. 10 depicts a process of a communication device, communicating with a server using a multipath session, being assigned additional sub-flows automatically, according to embodiments as disclosed herein. The server 102 checks (1001) if it at least one sub-flow is available. If at least one sub-flow is available, the server 102 checks (1002) if the available sub-flow(s) can be assigned to at least one communication device 101, wherein the communication device 101 can be in communication with the server using a multipath session. If the sub-flow can be assigned to more than one communication device 101, the server 102 can decide based on a plurality of factors comprising of the QoS levels of the communication devices, current bandwidth used by the communication devices across all sub-flows being used by the communication devices, pending requests for sub-flows from communication devices, date and time the request was received, and so on. On selecting a communication device, the server 102 assigns (1003) the sub-flows to the communication device 101 and the communication device 101 starts (1004) communicating with the server 102 using the new sub-flow(s). The various actions in method 1000 may be performed in the order presented, in a different order or simultaneously. Further, in some embodiments, some actions listed in FIG. 10 may be omitted.

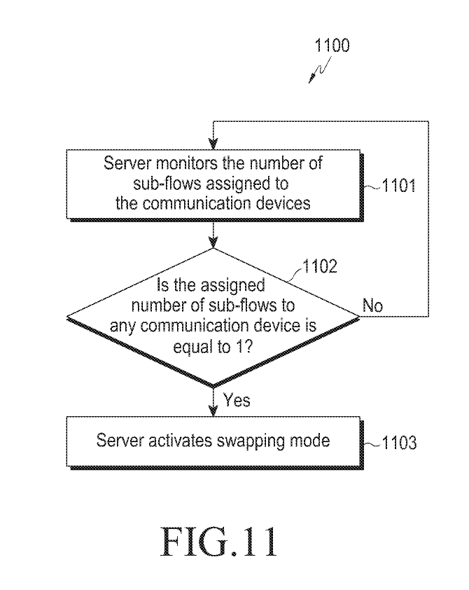

FIG. 11 is a flow chart depicting the process of the server managing the process of swapping sub-flows, according to embodiments as disclosed herein. The server 102 monitors (1101) the number of sub-flows assigned to the communication devices, which are currently communicating with the server 102 using multipath sessions. The server 102 checks (1102) if the assigned number of sub-flows to any communication device is equal to 1. If the assigned number of sub-flows is equal to 1, the server 102 activates (1103) swapping mode for the communication device 101. In the swapping mode, the server 102 enables the communication device 101 to switch the current sub-flow with another sub-flow in a manner transparent to the user. The various actions in method 1100 may be performed in the order presented, in a different order or simultaneously. Further, in some embodiments, some actions listed in FIG. 11 may be omitted.

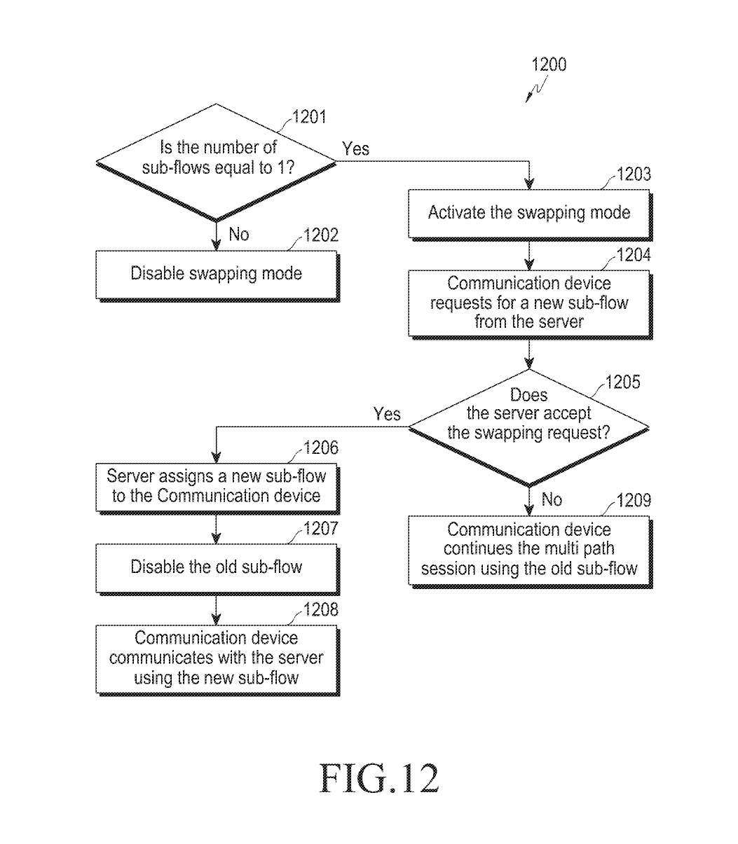

FIG. 12 is a flowchart depicting the process of the communication device swapping sub-flows, according to embodiments as disclosed herein. On the communication device 101 communicating using multipath sessions, the communication device 101 checks (1201) if the number of sub-flows being used is equal to 1. If the number of sub-flows is not equal to 1, the communication device 101 disables (1202) the swapping mode. If the number of sub-flows is equal to 1, the communication device 101 enables (1203) the swapping mode. The communication device 101 further requests (1204) for a new sub-flow from the server 102 using a communication interface, other than the interface being currently used by the communication device 101 for the multipath session. If the server 102 accepts (1205) the swapping request and assigns (1206) a new sub-flow to the communication device 101, the communication device 101 disables (1207) the old sub-flow and communicates (1208) using the new sub-flow. If the server 102 does not accept the swapping request, the communication device 101 continues (1209) the multi path session using the old sub-flow. The various actions in method 1200 may be performed in the order presented, in a different order or simultaneously. Further, in some embodiments, some actions listed in FIG. 12 may be omitted.

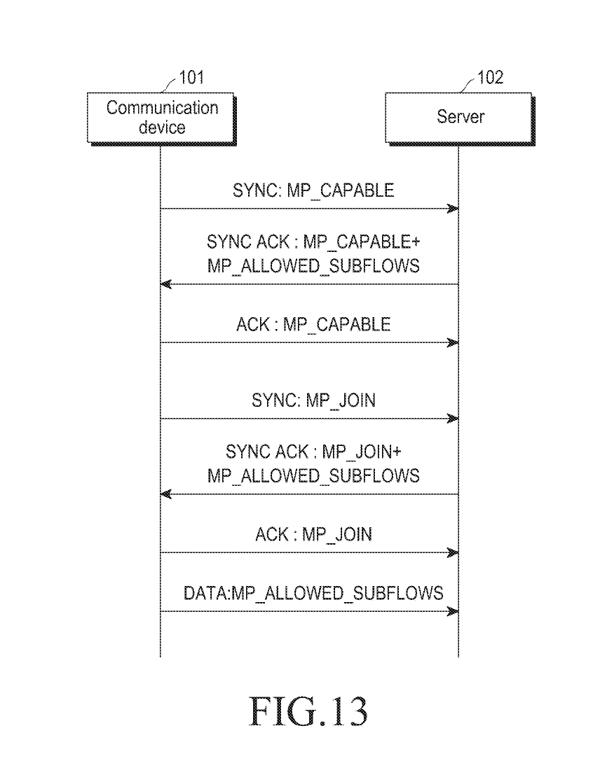

FIG. 13 is a sequence diagram depicting the flow of messages between the communication device and the server, on the communication device being assigned new sub-flows, according to embodiments as disclosed herein. The communication device 101 sends a first SYNC message comprising the MP_CAPABLE field to the server 102, on the communication device 101 initiating the multipath session. The server 102, in response, sends a first SYNC ACK message. The first SYNC ACK message comprises of the MP_CAPABLE field and MP_ALLOWED_SUBFLOWS field. The MP_ALLOWED_SUBFLOWS can be present in the MPTCP option field and denotes the number of sub-flows assigned to the communication device 101. The communication device 101 responds with a first ACK message, acknowledging the receipt of the SYNC ACK message. The communication device 101 further sends a second SYNC message to the server 102, when the communication device 101 joins the multipath session. The SYNC message comprises of the MP_JOIN field. The server 102, in response, sends a second SYNC ACK message. The second SYNC ACK message comprises of the MP_JOIN field and MP_ALLOWED_SUBFLOWS field. The MP_ALLOWED_SUBFLOWS can be present in the MPTCP option field. The communication device 101 responds with a second ACK message, acknowledging the receipt of the SYNC ACK message and starts exchanging data with the server 102 using the allowed number of sub-flows.

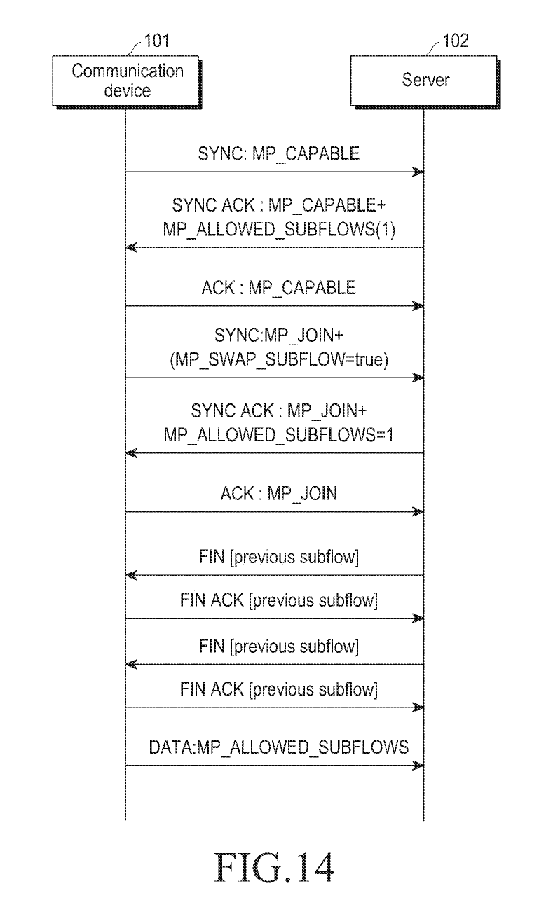

FIG. 14 is a sequence diagram depicting the flow of messages between the communication device and the server on the swapping sub-flows, according to embodiments as disclosed herein. The communication device 101 sends a first SYNC message comprising the MP_CAPABLE field to the server 102, on the communication device 101 initiating the multipath session. The server 102, in response, sends a first SYNC ACK message. The first SYNC ACK message comprises of the MP_CAPABLE field and MP_ALLOWED_SUBFLOWS field. The MP_ALLOWED_SUBFLOWS can be present in the MPTCP option field and denotes the number of sub-flows assigned to the communication device 101. Here, the number of sub-flows is 1. The communication device 101 responds with a first ACK message, acknowledging the receipt of the SYNC ACK message. The communication device 101 further sends a second SYNC message to the server 102, when the communication device 101 joins the multipath session. The SYNC message comprises of the MP_JOIN field and the MP_SWAP_SUBFLOW set to a value ‘true’. The server 102, in response, sends a second SYNC ACK message (on a sub-flow becoming available for swapping). The second SYNC ACK message comprises of the MP_JOIN field and MP_ALLOWED_SUBFLOWS field. The MP_ALLOWED_SUBFLOWS can be present in the MPTCP option field. The communication device 101 responds with a second ACK message, acknowledging the receipt of the SYNC ACK. The server 102 further instructs the communication device 101 to stop the current sub-flow, which the communication device 101 acknowledges. The communication device 101 further continues the multipath session using the new sub-flow.

Embodiments herein define application specific packets and the application specific packets are exchanged between the server and the communication device to determine allowed number of sub-flows and swapping the previous sub-flows.

In case of HTTP 2.0 using MPTCP, embodiments herein enable the server to open new sub-flows to push the messages containing allowed number of sub-flows on an existing TCP flow. In case of Multipath RTP, embodiments herein enable RTCP messages to be exchanged to convey the above described messages.

The embodiments disclosed herein can be implemented through at least one software program running on at least one hardware device and performing network management functions to control the elements. The elements shown in FIGS. 1, 2, 3, 4 and 5 can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

What is claimed is:

1. A method for managing a multipath communication session between a server and a communication device by the server, the method comprising:
determining at least one available sub-flow for the multipath communication session;
assigning the at least one available sub-flow to the communication device; and
performing communication with the communication device based on information related to the at least one available sub-flow.

2. The method, as claimed in claim 1, wherein the at least one available sub-flow is assigned based on a plurality of factors comprising of a request for at least one sub-flow transmitted from the communication device, a bandwidth being used by the communication device, quality of service (QoS) levels of the communication device, status of a swapping mode of the communication device, and available communication interfaces for the communication device.

3. The method, as claimed in claim 1, wherein the at least one available sub-flow is assigned to the communication device within a timeout period.

4. A method for managing a multipath communication session between a server and a communication device by the communication device, the method comprising:
receiving a notification related to at least one available sub-flow for the multipath communication session from the server; and
performing communication with the server based on the notification.

5. The method, as claimed in claim 4, further comprising adding the at least one available sub-flow to a list related to sub-flows used by the communication device.

6. The method, as claimed in claim 4, further comprising swapping an existing sub-flow with the at least one available sub-flow.

7. A server for managing a multipath communication session between the server and a communication device, the server comprising:
a controller configured to determine at least one available sub-flow for the multipath communication session, assign the at least one available sub-flow to the communication device; and
a communication interface configured to perform communication with the communication device based on information related to the at least one available sub-flow.

8. The server, as claimed in claim 7, wherein the at least one available sub-flow is assigned based on a plurality of factors comprising of a request for at least one sub-flow transmitted from the communication device, a bandwidth being used by the communication device, quality of service (QoS) levels of the communication device, status of a swapping mode of the communication device, and available communication interfaces for the communication device.

9. The server, as claimed in claim 7, wherein the at least one available sub-flow is assigned to the communication device within a timeout period.

10. The server, as claimed in claim 7, wherein the communication interface is further configured to perform the communication with the communication device based on a multipath transfer control protocol (MTPCP), and the MTPCP is used by a plurality communication interfaces for a single sub-flow.

11. A communication device for managing a multipath communication session between a server and the communication device, the communication device comprising:
a controller configured to control a communication interface; and
the communication interface configured to receive a notification related to at least one available sub-flow for the multipath communication session from the server, and perform communication with the server based on the notification.

12. The communication device, as claimed in claim 11, wherein the communication interface is further configured to transmit a request for at least one sub-flow to the server.

13. The communication device, as claimed in claim 11, wherein the controller is further configured to activate a swapping mode, if the communication device is using one sub-flow for communication.

14. The communication device, as claimed in claim 11, wherein the communication interface is further configured to enable the communication device to control at least one communication interface present on the communication device and at least one sub-flow.

15. The communication device, as claimed in claim 11, wherein the controller is further configured to add the at least one available sub-flow to a list related to sub-flows used by the communication device.

16. The communication device, as claimed in claim 11, wherein the controller is further configured for swapping an existing sub-flow with the at least one available sub-flow.

17. The communication device, as claimed in claim 11, wherein the communication interface is further configured to perform the communication with the server based on a multipath transfer control protocol (MTPCP), and the MTPCP is used by a plurality communication interfaces for a single sub-flow.

18. A method for managing a multipath communication session between a server and a communication device by the communication device, the method comprising:
receiving a notification related to at least one available sub-flow for the multipath communication session from the server;
displaying information related to available sub-flows for the multipath communication session and information related to sub-flows used currently by the communication device.

19. The method, as claimed in claim 18, wherein the information related to the available sub-flows for the multipath communication session includes a number of the available sub-flows for the multipath communication session, and
wherein the information related to the sub-flows used currently by the communication device includes a number of the sub-flows used currently by the communication device.

20. The method, as claimed in claim 18, wherein a format of the displayed information includes a number of the sub-flows used currently by the communication device/a number of the available sub-flows for the multipath communication session.
